(19) United States
(12) Patent Application Publication
(10) Pub. No.: US 2026/0319804 A1
(43) Pub. Date: Oct. 15, 2026

(54) Processing Vector Instructions

(71) Applicant: Imagination Technologies Limited, Kings Langley (GB)

(72) Inventors: Peter VRABEL, Hertfordshire (GB); Tai LI, Hertfordshire (GB); Sudheendra SRIVATHSA, Hertfordshire (GB); Selina HOPTON, Hertfordshire (GB)

(21) Appl. No.: 19/322,871

(22) Filed: Sep. 9, 2025

(30) Foreign Application Priority Data
Sep. 9, 2024 (GB) 2413194.8

(51) Int. Cl. G06F 9/38; G06F 9/30

(52) U.S. Cl. CPC G06F 9/3865; G06F 9/30036; G06F 9/30196; G06F 9/3802

(57) ABSTRACT

When an illegal instruction exception is detected by a processing unit, a signal is sent to an instruction fetch unit to re-fetch the original instruction encoding. The fetch unit fetches (but does not decode) the original instruction encoding and sends the instruction encoding to the control unit, such as the Central Processing Unit (CPU).

### CROSS-REFERENCE TO RELATED APPLICATIONS AND CLAIM OF PRIORITY

This application claims foreign priority under 35 U.S.C. 119 from United Kingdom Patent Application No. GB2413194.8 filed on 9 Sep. 2024, the contents of which are incorporated by reference herein in their entirety.

### TECHNICAL FIELD

The present disclosure relates to the processing of instructions by a vector processing unit.

### BACKGROUND

A vector processing unit (VPU) is responsible for executing vector instructions and scalar floating-point instructions, which may include cryptographic instructions. The VPU receives decoded instructions from a central unit (e.g. a main pipeline control (MPC)) and then executes the instructions. Execution is primarily performed by reading the vector or floating point register files, sending the data through a vector data path, and then writing the result back to the vector or floating point register file.

At a high level, to execute an instruction the system needs to: i) fetch the instruction encoding from memory, ii) decode the instruction, which involves processing the encoding into a set of control information that is more useful to the rest of the processing system (e.g. the type of instruction, which register(s) it reads/writes), and iii) send the decoded control to the relevant parts of the system, e.g. the central processing unit (CPU) or the VPU.

Some encodings are not associated with legal instructions. If a processing system attempts to execute such an encoding, it must generate an illegal instruction exception. Such an attempt might be caused due to a software error, or an invalid encoding of the instruction, amongst other things. Whether an encoding is legal might depend on the architectural state of the VPU (e.g. LMUL, the length multiplier register) or the processing system containing the VPU. Sometimes, the state is not known until the instruction control is received by the VPU and the VPU begins to process the instruction.

Some processing systems (including RISC-V systems) require that when an illegal instruction exception is detected, architectural state (e.g. a control and status register (CSR)) needs to be updated. For example, the architectural state may be required to store information about the original instruction encoding and information relating to the exception. In some cases, software that runs when an exception is detected needs to read the architectural state to determine why the exception was taken, in order to work out what action to take. This might include emulating an unsupported instruction in software, killing a failing thread and reporting to the OS, or failing gracefully if the exception is not recoverable from.

### SUMMARY

This Summary is provided merely to illustrate some of the concepts disclosed herein and possible implementations thereof. Not everything recited in the Summary section is necessarily intended to be limiting on the scope of the disclosure. Rather, the scope of the present disclosure is limited only by the claims.

In some systems, the VPU has to send the instruction encoding down the entire pipeline for any instruction that might get an illegal instruction exception, to the point where the illegal instruction exception is detected. Here, “pipeline” refers to whichever pipeline, or parts of a pipeline, needed to execute a VPU instruction up until the point where the illegal instruction exception can be detected. This will typically include pipeline inside the IFU (Instruction Fetch Unit), part of the MPC, and part of the VPU. In some cases, the illegal instruction exception is detected at the head (i.e. start) of the pipeline when the original encoding is still known, meaning that the original encoding has not been sent that far down the pipeline (in other words, the original encoding does not go through many stages of the pipeline). However, a problem arises when the exception is not detected at the head of the pipeline but is instead detected later in the pipeline, at which point the instruction encoding is not still known. This then requires sending the instruction encoding down the pipeline to the point at which the exception was detected, which is costly from an area and power perspective.

To solve this issue, according to embodiments of the present invention, when an illegal instruction exception is detected, a signal is sent to an instruction fetch unit (which is a unit configured to decode instructions) to re-fetch the original instruction encoding from memory. The fetch unit fetches (but does not decode) the original instruction encoding from memory. Here, the fault signal/flag informs the fetch unit that the instruction is illegal so that the fetch unit does not decode the instruction. This means that the illegal instruction exception is detected at the head of the pipeline when the encoding is known. The fetch unit then sends the exception, and the associated encoding, to the central processing unit (CPU), e.g. the main pipeline control (MPC). This informs the CPU of the exception, so that the necessary actions can be taken. For example, architectural sate (e.g. control and status registers) may be updated with the necessary exception information, and the instruction can be prevented from being sent again to the VPU.

This invention saves power and area compared to sending the instruction encoding down the pipeline of the VPU.

According to an aspect disclosed herein, there is provided a computer-implemented method of processing instructions by a processing system. The method comprises receiving, by a processing unit, a decoded version of an instruction and initiating processing of the instruction. The encoded instruction (i.e. the encoded version of the instruction, from which the decoded version is obtained) is not sent to or received by the processing unit. The method comprises detecting, by the processing unit, that the instruction is an illegal instruction, wherein an illegal instruction is an instruction that will generate an illegal exception, indicating that the instruction cannot be executed. In response, the processing unit sends, to an instruction fetch unit, a signal indicating that the instruction is an illegal instruction. The fault signal then sends, to a control unit, an encoded version of the instruction and exception information relating to the illegal exception.

In embodiments, the control unit may be configured to update architectural state of the processing system to include information about the encoded version of the instruction and/or the exception information.

In embodiments, the architectural state may be updated by the control unit comprises a system register.

In embodiments, the control unit may be configured to prevent the instruction from being re-sent to the processing unit.

In embodiments, the exception information may include a type of the illegal exception and/or an indication of where the illegal exception was detected.

In embodiments, the detecting of the illegal instruction may be based on architectural state of the processing system.

In embodiments, the architectural state upon which the detecting of the illegal instruction is based may not be known until said processing of the instruction is initiated.

In embodiments, the detecting of the illegal instruction may be based on control logic of the instruction.

In embodiments, processing of the instruction may comprise sending the instruction to a pipeline of the processing unit, and wherein the detecting of the illegal instruction may be performed by the pipeline of the processing unit.

In embodiments, the processing unit may be a vector processing unit.

According to another aspect disclosed herein, there is provided processing system comprising an instruction fetch unit, a control unit, and a processing unit. The processing unit is configured to receive a decoded version of an instruction and initiate processing of the instruction; detect that the instruction is an illegal instruction, wherein an illegal instruction an instruction that that will generate an illegal exception, indicating that the exception cannot be executed; and send, to an instruction fetch unit, a signal indicating that the instruction is an illegal instruction. The instruction fetch unit is configured to send, to the control unit, an encoded version of the instruction and exception information relating to the illegal exception. The control unit is configured to update architectural state of the processing system to include information associated with the encoded version of the instruction and/or the exception information, and/or prevent the instruction from being re-sent to the processing unit.

Embodiments will primarily be described in terms of instructions being sent and processed by a vector processing unit, with illegal exceptions being detected by the vector processing unit. However, in general, embodiments may apply to any unit/component of the processing system.

The processing system may be embodied in hardware on an integrated circuit. There may be provided a method of manufacturing, at an integrated circuit manufacturing system, a processing system. There may be provided an integrated circuit definition dataset that, when processed in an integrated circuit manufacturing system, configures the system to manufacture a processing system. There may be provided a non-transitory computer readable storage medium having stored thereon a computer readable description of a processing system that, when processed in an integrated circuit manufacturing system, causes the integrated circuit manufacturing system to manufacture an integrated circuit embodying a processing system.

There may be provided an integrated circuit manufacturing system comprising: a non-transitory computer readable storage medium having stored thereon a computer readable description of the processing system; a layout processing system configured to process the computer readable description so as to generate a circuit layout description of an integrated circuit embodying the processing system; and an integrated circuit generation system configured to manufacture the processing system according to the circuit layout description. The layout processing system may be configured to determine positional information for logical components of a circuit derived from the integrated circuit description so as to generate the circuit layout description of the integrated circuit embodying the graphics processing system.

There may be provided computer program code for performing any of the methods described herein. There may be provided non-transitory computer readable storage medium having stored thereon computer readable instructions that, when executed at a computer system, cause the computer system to perform any of the methods described herein.

The above features may be combined as appropriate, as would be apparent to a skilled person, and may be combined with any of the aspects of the examples described herein.

### BRIEF DESCRIPTION OF THE DRAWINGS

Examples will now be described in detail with reference to the accompanying drawings in which:

FIG. 1 shows an example processing system for processing instructions by a vector processing unit;

FIG. 2 shows an example process of handling an illegal instruction;

FIG. 3 shows a computer system in which a processing system is implemented; and

FIG. 4 shows an integrated circuit manufacturing system for generating an integrated circuit embodying a processing system.

The accompanying drawings illustrate various examples. The skilled person will appreciate that the illustrated element boundaries (e.g., boxes, groups of boxes, or other shapes) in the drawings represent one example of the boundaries. It may be that in some examples, one element may be designed as multiple elements or that multiple elements may be designed as one element. Common reference numerals are used throughout the figures, where appropriate, to indicate similar features.

### DETAILED DESCRIPTION

The following description is presented by way of example to enable a person skilled in the art to make and use the invention. The present invention is not limited to the embodiments described herein and various modifications to the disclosed embodiments will be apparent to those skilled in the art.

Embodiments will now be described by way of example only.

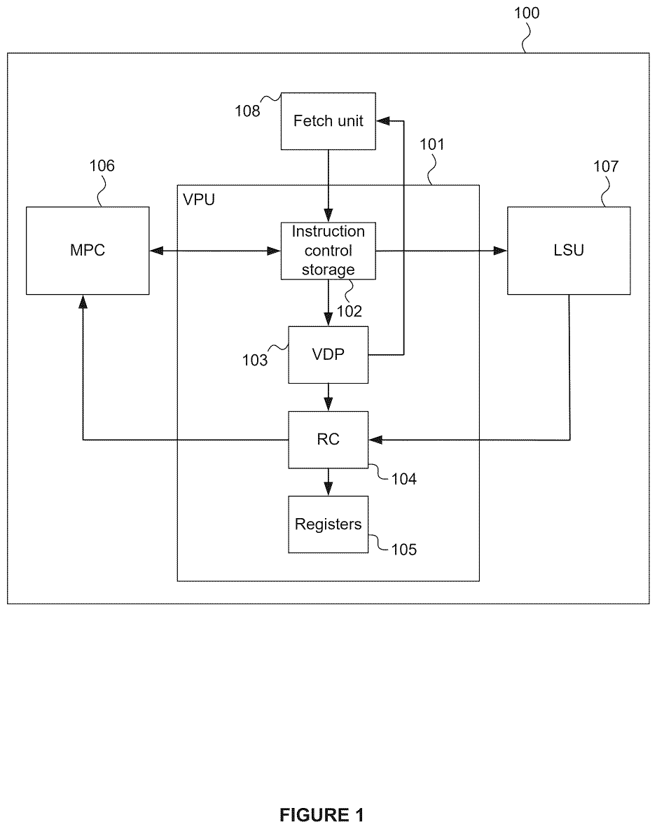

FIG. 1 illustrates an example processing system 100 for processing vector processing unit (VPU) instructions. Herein, a VPU instruction refers to any instruction processed (i.e. executed) by a VPU 101. For example, the instruction may be a vector instruction, a scalar floating-point instruction, a vector cryptographic instruction, or a matrix instruction.

The processing system 100 may be or form part of a RISC (e.g. RISC-V) processing system.

The VPU 101 typically includes instruction control storage 102 which contains control and tracking logic for micro-ops of VPU instructions. Some processing systems refer to the instruction control storage 102 as “an operation cache” (OC). Other systems may use a pipeline that is configured to handle the execution of vector instructions, instead of dedicated instruction control storage 102. Either way, the VPU 101 has storage for not-yet-dispatched instructions.

The VPU 101 will also typically include a vector data path (VDP) 103 configured to calculate the result of data-processing VPU instructions, and a “results cache” (RC) 104 configured to store data for VPU instructions which have executed but not yet written back to memory (e.g. one or more registers 105). The VPU 101 may comprise additional components.

The VPU 101 is configured to accept (i.e. receive) decoded VPU instruction control from a main pipeline control (MPC) 106 of a CPU. The MPC 106 is also commonly referred to as a data processing unit (DPU). Any reference to MPC below may be replaced with “control unit” or DPU, unless the context requires otherwise.

The processing system 100 comprises an interface between the VPU 101 and the MPC 106, the interface being configured to pass VPU instructions and data between the VPU 101 and the MPC 106. The VPU 101 is configured to receive decoded instructions from the MPC 106, and then execute the instructions. Execution is primarily performed by reading the vector or floating point register files, sending the data through the VDP 103, then writing the result back to the vector or floating point register file.

The processing system 100 also contains one or more interfaces between the VPU 101 and LSUs 107, the LSUs 107 being configured to perform vector loads and stores and floating point loads and stores.

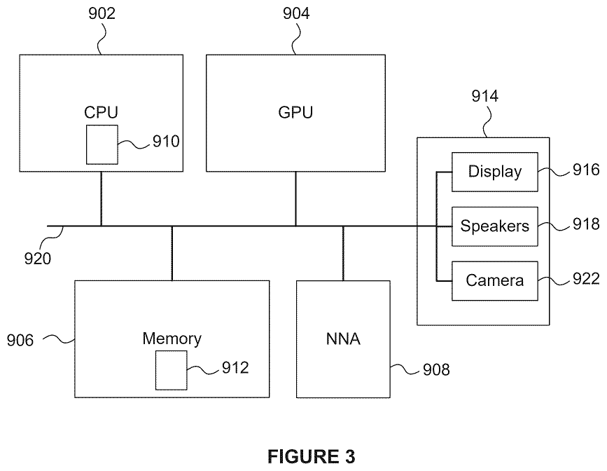

The processing system 100 also contains an instruction fetch unit (or simply, fetch unit) 108, and an interface between the VPU 101 and the fetch unit 108. The fetch unit is configured to obtain instruction encoding (i.e. encoded versions of instructions, also referred to herein as encoded instructions) from memory, such as memory 906 in FIG. 3. In general the memory that holds the encoded instructions may be positioned anywhere within the processing system 100. The fetch unit 108 is also configured to decode encoded versions of instructions, thus revealing the instructions.

The VPU 101, MPC 107 and LSU 108 are all components of a central processing unit (CPU), e.g. CPU 902 shown in FIG. 3.

The VPU 101 may, in some situations, run ahead of the MPC 106, meaning that some instructions may have finished executing, and have the result available, before the instruction has been architecturally committed. In this case, the result is written to the result cache 104 and then sent from the result cache 104 into the appropriate register file 105 once the instruction is committed.

The following definitions are used throughout the present disclosure. “Issue” refers to when an instruction is sent from the MPC 107 to the VPU 101. “Commit” refers to when an instruction or micro-op becomes guaranteed to update architectural state. It cannot do any such update until it's committed. “Execute” refers to when a micro-op produces a result (e.g. a result that can be written to the architectural state once the instruction is committed). “Writeback” refers to when the micro-op or instruction has finished updating architectural state (e.g. register 106) with a result.

VPU instructions are sent from the MPC 106 to the VPU 101 in order. Instructions may be executed and perform architectural updates out of order, both with respect to other MPC instructions, and also with respect to other VPU instructions.

Turning now to the handling of illegal instructions, i.e. instructions that give rise to illegal exceptions (indicating that an instruction cannot be executed). A processing unit, such as the VPU 101, is configured to receive an instruction (e.g. from the MPC 106) and begins processing the instruction. Note that whilst examples will mainly be described from the perspective of a VPU 101 receiving the instruction, the same will apply to other processing units, such as the LSU 107. The instruction may be received at the instruction control storage 102 of the VPU 101 and dispatched to the VDP 103 or the LSU 107. The VPU 101 (e.g. a component of the VPU 101 such as the VDP 103) or a component of the processing system 101, such as the LSU 107, is configured to determine that the instruction will produce (or has produced) an illegal exception. The component that determines that the instruction will produce the illegal exception (e.g. the VPU 101 or the LSU 107) may determine (i.e. detect) that the instruction is an illegal instruction based on architectural state, such as the number of registers to be operated on by the instruction (this is sometimes referred to as the length multiplier (LMUL)), and can be a fraction of a register. In some examples, the architectural state that may result in the instruction having an illegal exception may not be known at the point that the instruction is dispatched by the VPU 101. Some illegal instruction exceptions are caused by certain instructions that are only legal if the current element size is a certain subset of the possible values. For instance, a floating-point instruction might not be legal if the VPU 101 is set up to operate on 8-bit elements. Another example is a widening instruction, where the output element size is greater than the input size, and the architectural state is already set to the largest possible element size.

In response to determining that the instruction is an illegal instruction, a fault signal to the fetch unit 108. This informs the fetch unit 108 that the instruction is an illegal instruction. The fault signal may be sent by the VPU 101, the LSU 107, or a different component on the processing system. The fault signal may be sent by the component that detected the illegal instruction. The fault signal may contain an identifier of the illegal instruction.

The fetch unit 108 is configured to fetch the instruction encoding of the illegal instruction (i.e. the encoded version of the illegal instruction), and send the instruction encoding to the MPC 106, or more generally to the CPU. The fetch unit 108 may fetch the instruction encoding from memory of the processing system 100.

Exception information may also be sent to the MPC 106 by the fetch unit 108, either together with or separately from the instruction encoding. The exception information may include a type of exception. The exception information may include a location of the exception, e.g. the location of the instruction that detected the exception, or a location of the memory access that caused the exception.

The MPC 106 is configured to take one or more actions based on the instruction encoding and/or exception information. For example, the MPC 106 may update architectural state, such as a control and status register (CSR). The architectural state may be updated to include the instruction encoding and/or the exception information. Additionally or alternatively, the MPC 106 may be configured to prevent the same illegal instruction being sent to the VPU 101, thus avoiding the VPU 101 attempting to process an instruction that is known to cause an illegal exception.

Note that the above examples refer to an instruction being dispatched by the VPU 101. In other examples, the instruction may be split into multiple micro-ops, and the micro-ops are dispatched by the VPU 101. It may be an individual micro-op that gives rise to an exception.

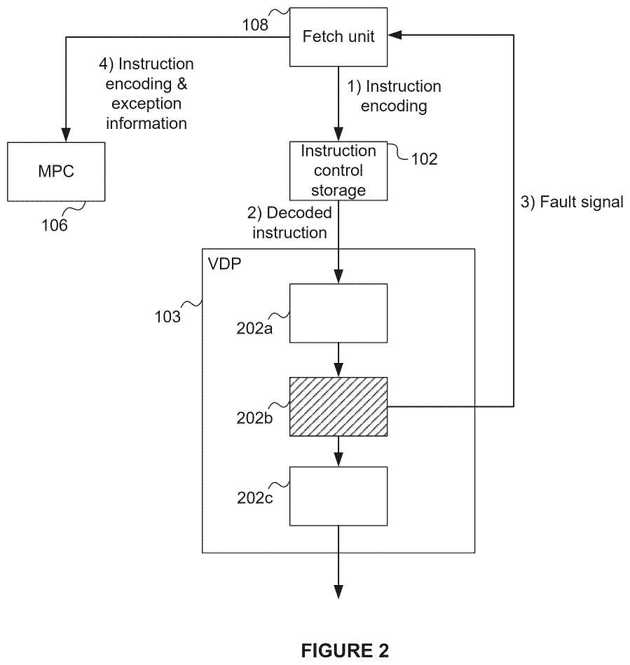

FIG. 2 schematically illustrates an example process for processing illegal instructions.

Note that this example involves an instruction being sent down a VDP 103 pipeline, and an illegal instruction being detected by the VDP 103. In other examples, the instruction may be sent down an LSU 107 pipeline and detected by the LSU 107. More generally, as discussed above, the examples described herein apply to any component/unit of the processing system that can detect an exception at a point where the original encoding is not available.

An instruction is received at the VPU, e.g. by the instruction control storage 102. The instruction is received in its decoded form/version. The instruction is sent down a pipeline of the VPU 101. For example, the instruction may be sent to one or more stages 202 of the VDP 103. Only three stages 202 of the VDP 103 are shown for illustrative purposes. Stage 202b (shown shaded in FIG. 2) detects (i.e. determines) that the instruction will give rise to an illegal exception. Note that in general any component of the VDP 103 may detect that the instruction will give rise to an illegal exception. In response to detecting that the instruction is an illegal instruction, the VDP 103 (e.g. stage 202b of the VDP 103) sends a fault signal to the fetch unit 108. The fault signal triggers the fetch unit 108 to fetch the encoded version of the instruction (e.g. from a store of instruction encodings). The fetch unit 108 does not decode the encoded version of the instruction, and instead sends the encoded version of the instruction to the MPC 106. The MPC 106 performs any necessary actions, such as updating the CSR with the exception information.

FIG. 3 shows a computer system in which processing systems described herein may be implemented. The computer system comprises a CPU 902, a GPU 904, a memory 906, a neural network accelerator (NNA) 908 and other devices 914, such as a display 916, speakers 918 and a camera 922. A processing block 910 (corresponding to processing blocks 101) is implemented on the CPU 902. In other examples, one or more of the depicted components may be omitted from the system, and/or the processing block 910 may be implemented on the GPU 904 or within the NNA 908. The components of the computer system can communicate with each other via a communications bus 920. A store 912 is implemented as part of the memory 906.

The processing system of FIGS. 1 and 2 are shown as comprising a number of functional blocks. This is schematic only and is not intended to define a strict division between different logic elements of such entities. Each functional block may be provided in any suitable manner. It is to be understood that intermediate values described herein as being formed by a processing system need not be physically generated by the processing system at any point and may merely represent logical values which conveniently describe the processing performed by the processing system between its input and output.

The processing system described herein may be embodied in hardware on an integrated circuit. The processing system described herein may be configured to perform any of the methods described herein. Generally, any of the functions, methods, techniques or components described above can be implemented in software, firmware, hardware (e.g., fixed logic circuitry), or any combination thereof. The terms “module,” “functionality,” “component”, “element”, “unit”, “block” and “logic” may be used herein to generally represent software, firmware, hardware, or any combination thereof. In the case of a software implementation, the module, functionality, component, element, unit, block or logic represents program code that performs the specified tasks when executed on a processor. The algorithms and methods described herein could be performed by one or more processors executing code that causes the processor(s) to perform the algorithms/methods. Examples of a computer-readable storage medium include a random-access memory (RAM), read-only memory (ROM), an optical disc, flash memory, hard disk memory, and other memory devices that may use magnetic, optical, and other techniques to store instructions or other data and that can be accessed by a machine.

The terms computer program code and computer readable instructions as used herein refer to any kind of executable code for processors, including code expressed in a machine language, an interpreted language or a scripting language. Executable code includes binary code, machine code, bytecode, code defining an integrated circuit (such as a hardware description language or netlist), and code expressed in a programming language code such as C, Java or OpenCL. Executable code may be, for example, any kind of software, firmware, script, module or library which, when suitably executed, processed, interpreted, compiled, executed at a virtual machine or other software environment, cause a processor of the computer system at which the executable code is supported to perform the tasks specified by the code.

A processor, computer, or computer system may be any kind of device, machine or dedicated circuit, or collection or portion thereof, with processing capability such that it can execute instructions. A processor may be or comprise any kind of general purpose or dedicated processor, such as a CPU, GPU, NNA, System-on-chip, state machine, media processor, an application-specific integrated circuit (ASIC), a programmable logic array, a field-programmable gate array (FPGA), or the like. A computer or computer system may comprise one or more processors.

It is also intended to encompass software which defines a configuration of hardware as described herein, such as HDL (hardware description language) software, as is used for designing integrated circuits, or for configuring programmable chips, to carry out desired functions. That is, there may be provided a computer readable storage medium having encoded thereon computer readable program code in the form of an integrated circuit definition dataset that when processed (i.e. run) in an integrated circuit manufacturing system configures the system to manufacture a processing system configured to perform any of the methods described herein, or to manufacture a processing system comprising any apparatus described herein. An integrated circuit definition dataset may be, for example, an integrated circuit description.

Therefore, there may be provided a method of manufacturing, at an integrated circuit manufacturing system, a processing system as described herein. Furthermore, there may be provided an integrated circuit definition dataset that, when processed in an integrated circuit manufacturing system, causes the method of manufacturing a processing system to be performed.

An integrated circuit definition dataset may be in the form of computer code, for example as a netlist, code for configuring a programmable chip, as a hardware description language defining hardware suitable for manufacture in an integrated circuit at any level, including as register transfer level (RTL) code, as high-level circuit representations such as Verilog or VHDL, and as low-level circuit representations such as OASIS® and GDSII. Higher level representations which logically define hardware suitable for manufacture in an integrated circuit (such as RTL) may be processed at a computer system configured for generating a manufacturing definition of an integrated circuit in the context of a software environment comprising definitions of circuit elements and rules for combining those elements in order to generate the manufacturing definition of an integrated circuit so defined by the representation. As is typically the case with software executing at a computer system so as to define a machine, one or more intermediate user steps (e.g. providing commands, variables etc.) may be required in order for a computer system configured for generating a manufacturing definition of an integrated circuit to execute code defining an integrated circuit so as to generate the manufacturing definition of that integrated circuit.

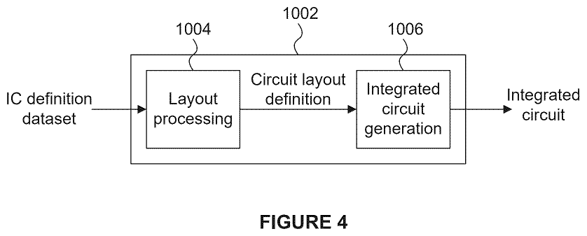

An example of processing an integrated circuit definition dataset at an integrated circuit manufacturing system so as to configure the system to manufacture a processing system will now be described with respect to FIG. 4.

FIG. 4 shows an example of an integrated circuit (IC) manufacturing system 1002 which is configured to manufacture a processing system as described in any of the examples herein. In particular, the IC manufacturing system 1002 comprises a layout processing system 1004 and an integrated circuit generation system 1006. The IC manufacturing system 1002 is configured to receive an IC definition dataset (e.g. defining a processing system as described in any of the examples herein), process the IC definition dataset, and generate an IC according to the IC definition dataset (e.g. which embodies a processing system as described in any of the examples herein). The processing of the IC definition dataset configures the IC manufacturing system 1002 to manufacture an integrated circuit embodying a processing system as described in any of the examples herein.

The layout processing system 1004 is configured to receive and process the IC definition dataset to determine a circuit layout. Methods of determining a circuit layout from an IC definition dataset are known in the art, and for example may involve synthesising RTL code to determine a gate level representation of a circuit to be generated, e.g. in terms of logical components (e.g. NAND, NOR, AND, OR, MUX and FLIP-FLOP components). A circuit layout can be determined from the gate level representation of the circuit by determining positional information for the logical components. This may be done automatically or with user involvement in order to optimise the circuit layout. When the layout processing system 1004 has determined the circuit layout it may output a circuit layout definition to the IC generation system 1006. A circuit layout definition may be, for example, a circuit layout description.

The IC generation system 1006 generates an IC according to the circuit layout definition, as is known in the art. For example, the IC generation system 1006 may implement a semiconductor device fabrication process to generate the IC, which may involve a multiple-step sequence of photo lithographic and chemical processing steps during which electronic circuits are gradually created on a wafer made of semiconducting material. The circuit layout definition may be in the form of a mask which can be used in a lithographic process for generating an IC according to the circuit definition. Alternatively, the circuit layout definition provided to the IC generation system 1006 may be in the form of computer-readable code which the IC generation system 1006 can use to form a suitable mask for use in generating an IC.

The different processes performed by the IC manufacturing system 1002 may be implemented all in one location, e.g. by one party. Alternatively, the IC manufacturing system 1002 may be a distributed system such that some of the processes may be performed at different locations, and may be performed by different parties. For example, some of the stages of: (i) synthesising RTL code representing the IC definition dataset to form a gate level representation of a circuit to be generated, (ii) generating a circuit layout based on the gate level representation, (iii) forming a mask in accordance with the circuit layout, and (iv) fabricating an integrated circuit using the mask, may be performed in different locations and/or by different parties.

In other examples, processing of the integrated circuit definition dataset at an integrated circuit manufacturing system may configure the system to manufacture a processing system without the IC definition dataset being processed so as to determine a circuit layout. For instance, an integrated circuit definition dataset may define the configuration of a reconfigurable processor, such as an FPGA, and the processing of that dataset may configure an IC manufacturing system to generate a reconfigurable processor having that defined configuration (e.g. by loading configuration data to the FPGA).

In some embodiments, an integrated circuit manufacturing definition dataset, when processed in an integrated circuit manufacturing system, may cause an integrated circuit manufacturing system to generate a device as described herein. For example, the configuration of an integrated circuit manufacturing system in the manner described above with respect to FIG. 4 by an integrated circuit manufacturing definition dataset may cause a device as described herein to be manufactured.

In some examples, an integrated circuit definition dataset could include software which runs on hardware defined at the dataset or in combination with hardware defined at the dataset. In the example shown in FIG. 4, the IC generation system may further be configured by an integrated circuit definition dataset to, on manufacturing an integrated circuit, load firmware onto that integrated circuit in accordance with program code defined at the integrated circuit definition dataset or otherwise provide program code with the integrated circuit for use with the integrated circuit.

The implementation of concepts set forth in this application in devices, apparatus, modules, and/or systems (as well as in methods implemented herein) may give rise to performance improvements when compared with known implementations. The performance improvements may include one or more of increased computational performance, reduced latency, increased throughput, and/or reduced power consumption. During manufacture of such devices, apparatus, modules, and systems (e.g. in integrated circuits) performance improvements can be traded-off against the physical implementation, thereby improving the method of manufacture. For example, a performance improvement may be traded against layout area, thereby matching the performance of a known implementation but using less silicon. This may be done, for example, by reusing functional blocks in a serialised fashion or sharing functional blocks between elements of the devices, apparatus, modules and/or systems. Conversely, concepts set forth in this application that give rise to improvements in the physical implementation of the devices, apparatus, modules, and systems (such as reduced silicon area) may be traded for improved performance. This may be done, for example, by manufacturing multiple instances of a module within a predefined area budget.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein. In view of the foregoing description it will be evident to a person skilled in the art that various modifications may be made within the scope of the invention.

What is claimed is:

1. A computer-implemented method of processing instructions by a processing system, the method comprising:
receiving, by a processing unit, a decoded version of an instruction and initiating processing of the instruction;
detecting, by the processing unit, that the instruction is an illegal instruction, wherein an illegal instruction is an instruction that will generate an illegal exception, indicating that the instruction cannot be executed;
sending, by the processing unit to an instruction fetch unit, a signal indicating that the instruction is an illegal instruction; and
sending, by the instruction fetch unit to a control unit, an encoded version of the instruction and exception information relating to the illegal exception.

2. The method of claim 1, wherein the control unit is configured to update architectural state of the processing system to include information associated with the encoded version of the instruction and/or the exception information.

3. The method of claim 2, wherein the architectural state updated by the control unit comprises a system register.

4. The method of claim 1, wherein the control unit is configured to prevent the instruction from being re-sent to the processing unit.

5. The method of claim 1, wherein the exception information includes a type of the illegal exception and/or an indication of where the illegal exception was detected.

6. The method of claim 1, wherein said detecting is based on architectural state of the processing system.

7. The method of claim 6, wherein the architectural state upon which said detecting is based is not known until said processing of the instruction is initiated.

8. The method of claim 1, wherein said detecting is based on control logic of the instruction.

9. The method of claim 1, wherein said processing of the instruction comprises sending the instruction to a pipeline of the processing unit, and wherein said detecting is performed by the pipeline of the processing unit.

10. The method of claim 1, wherein the processing unit is a vector processing unit.

11. The method of claim 9, wherein the pipeline comprises at least part of a data path of the processing unit and/or at least part of a load-store unit of the processing system.

12. A computer program embodied on a non-transitory computer-readable storage medium and configured so as when run on a processing system, the processing system performs a method of processing instructions by a processing system, the method including:
receiving, by a processing unit, a decoded version of an instruction and initiating processing of the instruction;
detecting, by the processing unit, that the instruction is an illegal instruction, wherein an illegal instruction is an instruction that will generate an illegal exception, indicating that the instruction cannot be executed;
sending, by the processing unit to an instruction fetch unit, a signal indicating that the instruction is an illegal instruction; and
sending, by the instruction fetch unit to a control unit, an encoded version of the instruction and exception information relating to the illegal exception.

13. A processing system comprising an instruction fetch unit, a control unit, and a processing unit;
wherein the processing unit is configured to:
receive a decoded version of an instruction and initiate processing of the instruction;
detect that the instruction is an illegal instruction, wherein an illegal instruction an instruction that that will generate an illegal exception, indicating that the exception cannot be executed; and
send, to an instruction fetch unit, a signal indicating that the instruction is an illegal instruction;
wherein the instruction fetch unit is configured to send, to the control unit, an encoded version of the instruction and exception information relating to the illegal exception, and
wherein the control unit is configured to:
update architectural state of the processing system to include information associated with the encoded version of the instruction and/or the exception information; and/or
prevent the instruction from being re-sent to the processing unit.

14. The processing system of claim 13, wherein the exception information includes a type of illegal exception and/or an indication of where the illegal exception was detected.

15. The processing system of claim 13, wherein the processing unit is configured to detect that the instruction will generate the illegal exception based on architectural state of the processing system.

16. The processing system of claim 13, wherein the architectural state upon which said detecting is based is not known until said processing of the instruction is initiated.

17. The processing system of claim 13, wherein the processing unit is configured to detect that the instruction will generate the illegal exception based on control logic of the instruction.

18. The processing system of claim 13, wherein the processing unit comprises a pipeline, and wherein the processing unit is configured to process the instruction by sending the instruction to the pipeline, and wherein the pipeline is configured to detect that the instruction is an illegal instruction.

19. The processing system of claim 13, wherein the processing unit is a vector processing unit.

20. The processing system of claim 18, wherein the pipeline comprises at least part of a data path of the processing unit and/or at least part of a load-store unit of the processing system.
